(19) United States
(12) Patent Application Publication
(10) Pub. No.: US 2006/0067306 A1
(43) Pub. Date: Mar. 30, 2006

(54) Space diversity receiver

(75) Inventor: Masanori Sugai, Aiichi (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 11/227,915

(22) Filed: Sep. 16, 2005

(30) Foreign Application Priority Data
Sep. 30, 2004 (JP) 2004-288795

(51) Int. Cl. H04B 7/08; H04B 1/06

(52) U.S. Cl. 370/352; 455/277.1; 455/140

(57) ABSTRACT

A space diversity receiver is provided in which missing data can be prevented with a simple configuration even if there occur some errors in the frame synchronous pattern.

The space diversity receiver having first and second reception antennas 4, 5 that receive packet data in which a predetermined frame synchronous pattern is inserted in every fixed period to be compared with the predetermined frame synchronous pattern so that whether to employ packet data X1 received by the first antenna 4 or to employ packet data X2 received by the second antenna 5 is determined, includes exclusive NOR circuits 20, 21 in which the frame synchronous patterns of the packet data X1 and X2 received by the first and second reception antennas 4, 5 and the predetermined frame synchronous pattern are compared to employ the packet data received by the reception antenna having a larger number of bits matched.

### CROSS REFERENCES TO RELATED APPLICATIONS

The present invention contains subject matter related to Japanese Patent Application JP 2004-288795 filed in the Japanese Patent Office on Sep. 30, 2004, the entire contents of which being incorporated herein by reference.

### BACKGROUND OF THE INVENTION

1. Field of the Invention

The present invention relates to a space diversity receiver that receives packet data (digital data) transmitted, with the space diversity.

Typically, a space diversity system as shown in FIG. 1 is used to transmit packet data. This space diversity system is the one in which data signals are received by two reception antennas to be used after selecting the reception signals, and since the phase relationship between the direct wave and interfering wave in each reception antenna is different due to the difference in positions of the two antennas, the characteristics thereof are used to reduce fading.

FIG. 1 shows a packet data transmitter 1 that transmits packet data from a transmission antenna 2.

As shown in FIG. 2, the packet data is digital data in which a predetermined frame synchronous pattern of, for example, 10 bits such as “1101100110” is inserted in every fixed period, and transmission data desired follows each frame synchronous pattern.

Further, a space diversity receiver 3 includes two reception antennas 4 and 5, and these two reception antennas 4 and 5 receive transmitted packet data X that is propagated through different space propagation paths A and B, respectively.

Typically, the packet data X1 and X2 respectively received by the two reception antennas 4 and 5 have differences in the field strengths and data errors due to the passing through the different space propagation paths A and B. In this space diversity receiver 3, either the received packet data X1 or X2, which has a preferable condition, is employed. In order to employ the received packet data having a preferable condition, the one that uses a frame synchronous pattern has been proposed. A receiver of related art that uses the frame synchronous packet in the received packet data is explained with reference to FIG. 3.

FIG. 3 shows shift-registers 6 and 7 to which a frame synchronous pattern of, for example, 10 bit of packet data respectively received by reception antennas 4 and 5, are sequentially input. Further, frame synchronous pattern generating circuits 8 and 9 generate a predetermined frame synchronous pattern of, for example, “110110110” in the data to be received.

Further, a comparator 10 compares the frame synchronous pattern supplied to the shift-register 6 of the packet data X1 received by the reception antenna 4 with the predetermined frame synchronous pattern, in the data to be received, from the frame synchronous pattern generating circuit 8, and the comparator 10 generates a frame synchronous flag when those frame synchronous patterns completely match, and then this frame synchronous flag is supplied to a data selector 11 and this data selector 11 supplies to a receiver main body 3a the packet data Xi received from the reception antenna 4.

Further, a comparator 12 compares the frame synchronous pattern supplied to the shift-register 7 of the packet data X2 received by the reception antenna 5 with the predetermined frame synchronous pattern, in the data to be received, from the frame synchronous pattern generating circuit 9, and the comparator 12 generates a frame synchronous flag when those frame synchronous patterns completely match, and then this frame synchronous flag is supplied to the data selector 11 and this data selector 11 supplies to the receiver main body 3a the packet data X2 received from the reception antenna 5.

In other words, in an example of related art of FIG. 3, when the received frame synchronous pattern and the predetermined frame synchronous pattern completely match, the received packet data is employed.

However, a frame synchronous pattern typically has a data length of some extent so that the pattern can easily be distinguished from transmission data, and therefore, if the frame synchronous flag is generated only when completely matched, with one or two bit errors due to a long data length such as 10 bits, for example, it is judged that the synchronous failure occurs. In that case, the head of the received data may not be found even with such small errors and data for one packet will be missing when both the received packet data X1 and X2 fail in synchronization, and therefore there is an inconvenience of causing considerable influences such as noise, no sound and so on, when continuous data such as voice data is transmitted.

### SUMMARY OF THE INVENTION

It is desirable to provide a space diversity receiver in which no missing data occur with a simple configuration even if there are some errors in a frame synchronous pattern.

A space diversity receiver according to an embodiment of the present invention, having first and second reception antennas that receive packet data in which a predetermined frame synchronous pattern is inserted in every fixed period to be compared with the predetermined frame synchronous pattern so that whether to employ the packet data received by the first antenna or to employ the packet data received by the second antenna is determined, includes exclusive NOR circuits in which the frame synchronous patterns of the packet data received by said first and second reception antennas and the predetermined frame synchronous pattern are compared to employ the packet data received by the reception antenna having a larger number of bits matched.

According to an embodiment of the present invention, since the frame synchronous patterns of the packet data received by the first and second reception antennas and the predetermined frame synchronous pattern are compared in exclusive NOR circuits and the packet data received by the reception antenna having a larger number of bits matched is employed, noise, no-sound and so on can be prevented without missing packet data even if there are some errors in the frame synchronous pattern of bits.

Further, according to an embodiment of the present invention, since the comparison is made in the exclusive NOR circuit, the configuration can be simplified.

### BRIEF DESCRIPTION OF THE DRAWINGS

FIG. 1 is a constitutional diagram provided to explain a space diversity system;

FIG. 2 is a diagram showing an example of packet data;

FIG. 3 is a configuration diagram showing an example of a space diversity receiver of related art;

FIG. 4 is a constitutional diagram showing a space diversity receiver according to an embodiment of the present invention; and

FIG. 5 is a diagram provided to explain an embodiment of the present invention.

### DESCRIPTION OF THE PREFERRED EMBODIMENTS

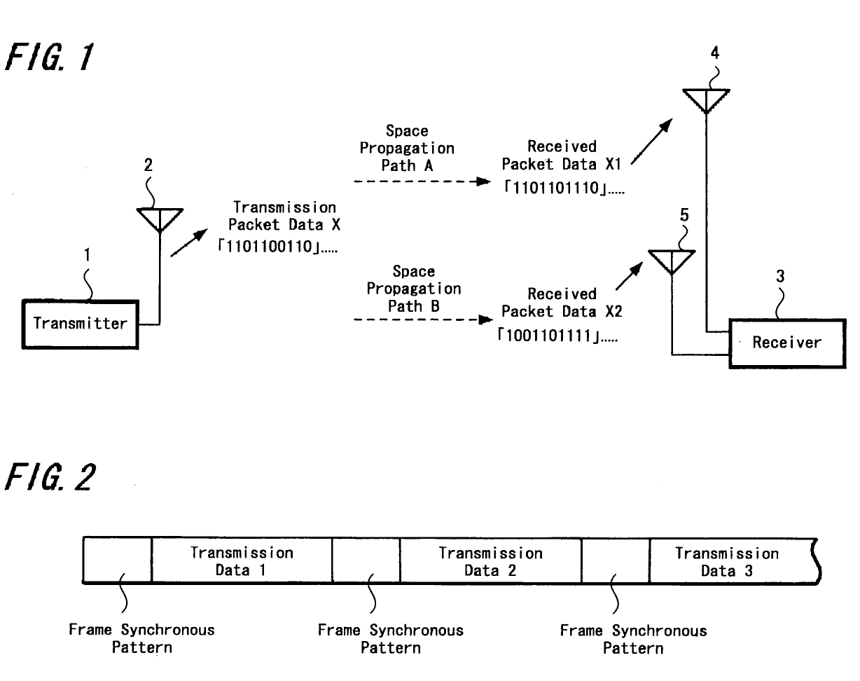

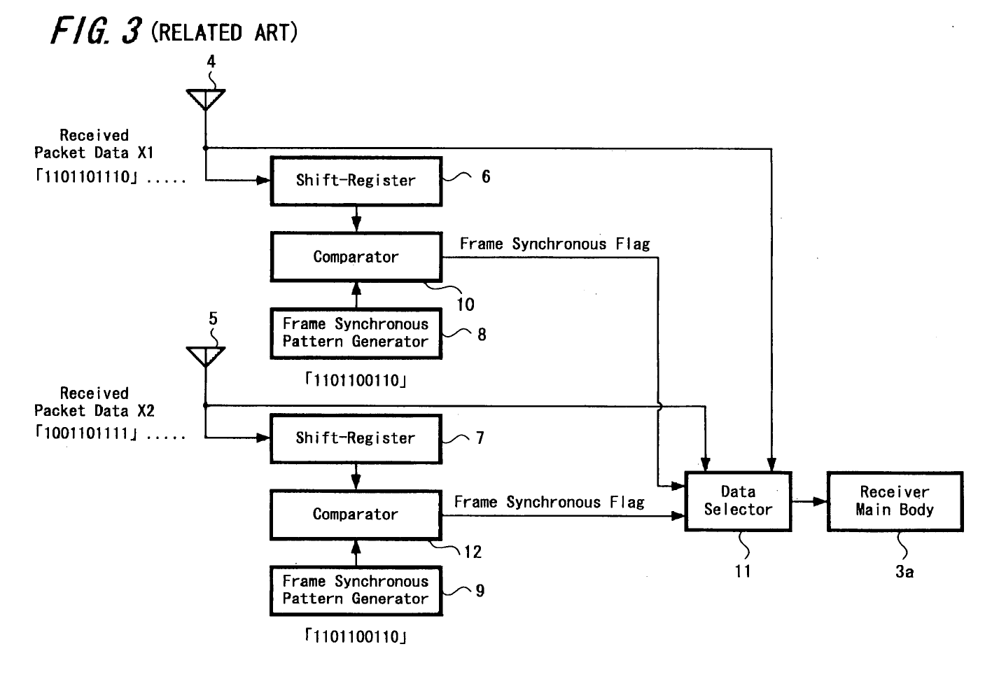

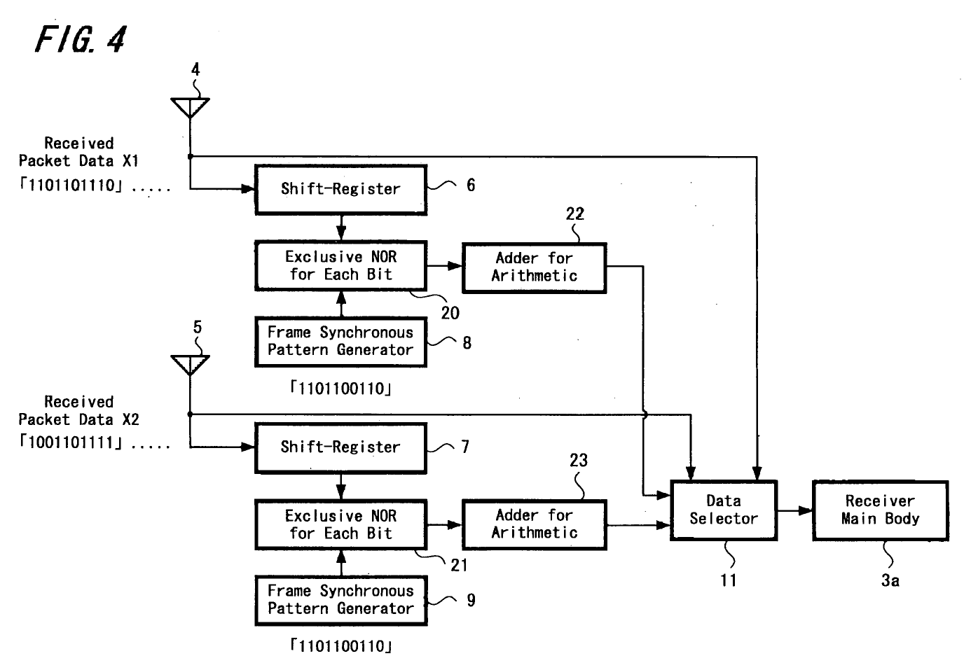

Hereinafter, an embodiment of a space diversity receiver of the present invention is explained with reference to FIGS. 4, 5 and FIG. 1, and units in FIG. 4 which correspond to those in FIG. 3 are denoted by the same reference numerals.

This embodiment is a space diversity receiver as shown in FIG. 1, in which packet data transmitted from a transmission antenna 2 of a packet data transmitter 1 is received with the space diversity.

As shown in FIG. 2, the packet data is digital data in which a predetermined frame synchronous pattern of, for example, 10 bits such as “1101100110” is inserted in every fixed period, and transmission data desired continues after each frame synchronous pattern.

A space diversity receiver 3 to receive the packet data with the space diversity includes two reception antennas 4 and 5, and the two reception antennas 4 and 5 receive transmission packet data X propagated through different space propagation paths A and B, respectively.

Typically, packet data X1 and X2 received by the two reception antennas 4 and 5 have differences in field strengths and data errors due to the passing through the different space propagation paths A and B. In this space diversity receiver 3, either the received packet data X1 or X2, which has a preferable condition, is employed.

As shown in FIG. 4, a frame synchronous pattern is used in this embodiment to employ the received packet data with a preferable condition.

In this embodiment, the packet data X1 received by the reception antenna 4 is supplied to a shift-register 6 and to a data selector 11. In this case, the frame synchronous pattern of, for example, 10 bits of this packet data X1 is sequentially supplied to the shift-register 6 in every fixed period and is stored. For example, the frame synchronous pattern of “1101101110” of this packet data X1 is stored.

Further, the packet data X2 received by the reception antenna 5 is supplied to a shift-register 7 and to a data selector 11. In this case, the frame synchronous pattern of, for example, 10 bits of this packet data X2 is sequentially supplied to the shift-register 7 in every fixed period and is stored. For example, the frame synchronous pattern of “1001101111” of this packet data X2 is stored.

Furthermore, in this embodiment, the frame synchronous pattern of, for example, “1101100110” of the data to be received is generated from frame synchronous pattern generating circuits 8 and 9.

In this embodiment, the frame synchronous pattern of, for example, “1101101110” of the packet data X1 from the shift-register 6 is supplied to one of input terminals of an exclusive NOR circuit 20 and the predetermined frame synchronous pattern of, for example, “1101100110” from the frame synchronous pattern generating circuit 8 is supplied to the other input terminal of the exclusive NOR circuit 20, thereby obtaining the exclusive NOR for each bit.

Further, the frame synchronous pattern of, for example, “1001101111” of the packet data X2 from the shift-register 7 is supplied to one of input terminals of an exclusive NOR circuit 21 and the predetermined frame synchronous pattern of, for example, “1001100110” from the frame synchronous pattern generating circuit 9 is supplied to the other input terminal of the exclusive NOR circuit 21, thereby obtaining the exclusive NOR for each bit.

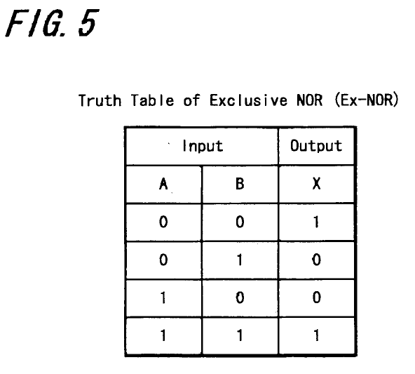

A truth-value in the exclusive NOR circuits 20 and 21 is shown in FIG. 5, in which the output X is “1” when one input A and the other input B match with “0” or “1” and the output X is “0” when one input A and the other input B are different, namely “0” “1” or “1” “0”.

Accordingly, the exclusive NOR circuits 20 and 21 output “1” when each bit of the frame synchronous pattern from the shift-registers 6, 7 and each bit of the frame synchronous pattern from the frame synchronous pattern generating circuits 8, 9 match, and output “0” when those do not match.

Signals output from the exclusive NOR circuits 20 and 21 are supplied to adders 22 and 23 for the arithmetic, respectively. In the adders 22 and 23 for the arithmetic, the number of “1” of output signal matched is added, and the value of the arithmetic result is supplied to the data selector 11 when this addition exceeds the threshold value, for example, “7”.

In this embodiment, the received packet data with a larger value from the adders 22 and 23 is employed and supplied to the receiver main body 3a from the data selector 11.

For example, in the case where the frame synchronous pattern of the received packet data X1 is “1101101110”, 9 bits match with the predetermined frame synchronous pattern of, for example, “1101100110” and therefore the value of adder 22 is “9” and exceeds the threshold value “7”, and in the case where the frame synchronous pattern of the received packet data X2 is “1001101111” for example, 7 bits match with the predetermined frame synchronous pattern of, for example, “1101100110” and therefore the value of adder 23 is “7” and exceeds the threshold value “7”, however, because the value of the adder 22 is larger than that, the data selector 11 employs the packet data X1 received from the reception antenna 4 and supplies the received packet data X1 to the receiver main body 3a.

When the values of adders 22, 23 do not exceed the threshold value “7” for example, the synchronization is considered to have failed.

According to the configuration of the above described embodiment, since the frame synchronous patterns of the packet data X1 and X2 received by the first and second reception antennas 4 and 5 and the predetermined frame synchronous pattern are compared in the exclusive NOR circuits 22, 23 and the packet data received by the reception antenna with a larger number of bits matched is employed, noise, no-sound and so on can be prevented without missing packet data even if there are a few bits, for example from 1 to 3 bits, of errors in the frame synchronous patterns.

Further, according to this embodiment, since the comparison is made in the exclusive NOR circuit, the configuration can be simplified.

It should be understood by those skilled in the art that various modifications, combinations, sub-combinations and alterations may occur depending on design requirements and other factors insofar as they are within the scope of the appended claims or the equivalents thereof.

What is claimed is:

1. A space diversity receiver including first and second reception antennas that receive packet data in which a predetermined frame synchronous pattern is inserted in every fixed period to be compared with the predetermined frame synchronous pattern so that whether to employ the packet data received by said first antenna or to employ the packet data received by said second antenna is determined, comprising exclusive NOR circuits in which the frame synchronous patterns of the packet data received by said first and second reception antennas and the predetermined frame synchronous pattern are compared to employ the packet data received by the reception antenna having a larger number of bits matched.

2. A space diversity receiver according to claim 1,
wherein said number of bit matched is a predetermined threshold value or more.

3. A space diversity receiver including first and second reception antennas that receive packet data in which a predetermined frame synchronous pattern is inserted in every fixed period to be compared with the predetermined frame synchronous pattern so that whether to employ the packet data received by said first antenna or to employ the packet data received by said second antenna is determined, comprising
first and second shift-registers which store a frame synchronous pattern of the packet data received by said first and second reception antennas, respectively;
first and second exclusive NOR circuits in which the first and second frame synchronous patterns stored in said first and second shift-registers are compared with the predetermined frame synchronous pattern, respectively;
first and second adders which count the output of said first and second exclusive NOR circuits, respectively: and
a data selector which compares the output value of said first and second adders and supplies to the receiver the packet data received by the reception antenna having a larger output value.
